(19) United States
(12) Patent Application Publication
(10) Pub. No.: US 2015/0211284 A1
(43) Pub. Date: Jul. 30, 2015

(54) Modular Visitation Station

(71) Applicant: Brian Moon, Sycamore, IL (US)

(72) Inventor: Brian Moon, Sycamore, IL (US)

(73) Assignee: THE NORIX GROUP, West Chicago, IL (US)

(21) Appl. No.: 14/609,428

(22) Filed: Jan. 29, 2015

Related U.S. Application Data
(60) Provisional application No. 61/933,097, filed on Jan. 29, 2014.

(51) Int. Cl. E05G 7/00; E04H 3/08

(52) U.S. Cl. CPC E05G 7/002; E04H 3/08

(57) ABSTRACT

The invention is directed to a modular visitation station having an expandable construction to adapt to provide individual visitation modules interwired together in a combination of back-to-back or side-by-side configurations. The visitation station may utilize single utility access for power or communications to connect each attached visitation module. Wiring access is provided between modules, and to the floor, wall or ceiling access points.

### FIELD OF THE INVENTION

The present invention relates generally to a modular non-contact visitation station for use in visitation and processing of individuals in a custodial setting such as jails or prisons to isolate an inmate from visitors.

### BACKGROUND OF THE INVENTION

Visitation stations are used to provide non-contact or visitation between individuals in settings such as jails, security institutions, or hospitals to allow visitation without allowing physical contact between the visitors. Prior art visitation stations are custom enclosures having see-through windows or facilities for mounting telephone equipment, video monitors or other communication equipment.

Prior art visitation stations are constructed of wood or plastic or metal and may be limited by the strength and size of interlinking parts. Interlinking adjacent stations together may be unsafe due to utility connections daisy chained between adjacent stations and in intensive use applications the integral linking of stations may create safety hazards or expensive retrofits. In addition, in intensive use applications such as prisons and jails, wood or other components may be disassembled to fashion weapons from the resulting pieces.

Multiple stations are formed by building individual stations ganged together to create a multi user assembly. Inter-station wiring is run by drilling though adjacent or intermediate walls along wire raceways in legs or the enclosure.

This application is a continuation of co-pending U.S. Provisional Application Ser. No. 61/929,766 filed Jan. 29, 2014 and claims the benefit of the filing date of said co-pending provisional Application Ser. No. 61/929,766.

### FIELD OF THE INVENTION

The present invention relates generally to a modular non-contact visitation station for use in visitation and processing of individuals in a custodial setting such as jails or prisons to isolate an inmate from visitors.

### BACKGROUND OF THE INVENTION

Visitation stations are used to provide non-contact or visitation between individuals in settings such as jails, security institutions, or hospitals to allow visitation without allowing physical contact between the visitors. Prior art visitation stations are custom enclosures having see-through windows or facilities for mounting telephone equipment, video monitors or other communication equipment.

Prior art visitation stations are constructed of wood or plastic or metal and may be limited by the strength and size of interlinking parts. Interlinking adjacent stations together may be unsafe due to utility connections daisy chained between adjacent stations and in intensive use applications the integral linking of stations may create safety hazards or expensive retrofits. In addition, in intensive use applications such as prisons and jails, wood or other components may be disassembled to fashion weapons from the resulting pieces.

Multiple stations are formed by building individual stations ganged together to create a multi user assembly. Inter-station wiring is run by drilling though adjacent or intermediate walls along wire raceways in legs or the enclosure.

Each of these prior art designs requires additional labor cost and time to install and configure. Therefore, it is desirable to provide a modular visitation station for adaptation in single or multi-ganged installations mounted on a floor or wall. It is further desirable to provide an expandable visitation station allowing a common utility connection to be expanded to adjacent units and having an interconnecting means between stations of sufficient strength and adaptability to interconnect a large number of visitation stations. The expandable visitation station allowing expandability to a back-to-back far side by side configuration.

### BRIEF SUMMARY OF THE INVENTION

One embodiment of the present invention is directed to a modular visitation station having modular sides built on an expandable base to form a side by side or back to back station with integral wiring pathway in the base, divider panels and modular legs. The visitation station comprises a plurality of interwired and attached visitation modules adapted to provide a use with non-contact with another user. The base may have a modular design having a plurality of fastener holes on the bottom surface, a wire raceway extending through the base from the bottom surface to the top surface and a sloped writing top surface to discourage the placement of drinking cups. The wiring raceway is provided in the base to facilitate power and communication connections from the floor to the equipment enclosure. A single base may be configured for a single visitation module or may be configured for multiple visitation modules separated by divider panels. Additional bases may be attached to the modular visitation station to expand the number of interconnected modules.

A panel being an end panel or isolating divider panel is placed at both sides of each module to isolate adjacent visitors and provide privacy from passers by. Each end panel has a sound absorber surface adjacent the base and an outside surface. The sound absorbers may have an opening on an inside surface of the end panel or isolation panel adjacent the base plate. The isolation or divider panel is mounted between side-by-side adjacent visitation modules. The divider panel may have a sound absorber on both sides to provide privacy from adjacent users.

The visitation station may have a faceplate on the base and spaced from the outer edge of the base to allow use of a writing area. The faceplate may be a window, a mounting surface, video screen or mounting surface for a camera, display, or other equipment to facilitate non-contact visitation. The faceplate may be in wiring communication with an adjacent equipment enclosure. The visitation station may further be configured with integral seating adapted to position the user in front of the faceplate.

An equipment space is defined between the end panels or isolation panels and behind the faceplate. This equipment space forms an enclosure having wire openings in the base, divider panel, top and back panel and to the faceplate for mounted equipment, utility connections and interwiring adjacent visitation modules. The back-to-back visitation station may have an equipment space configured between opposing faceplates. Single sided side-by-side modules may define the equipment space between a back panel and faceplate. The equipment enclosure is further enclosed by the base, an end panel or divider panel on either side and top panel on the top. Equipment mounted in the equipment enclosure may provide lighting, video or audio communication to a user of the visitation station. Power and communication connections may also be mounted in this space. Each equipment enclosure is in wiring communication with attached equipment enclosures on the visitation station.

The means for supporting the modular visitation station may comprise a wall mount adapter for attaching to an existing wall or legs to hold the visitation station in a stand alone configuration or both wall mount and legs. Legs may be attached to the bottom surface either ganged together or attached individually. The legs may have a foot adapted to engage the floor on one end and a flange adapted to engage the base on another end. The wire raceway may be integral to the leg to extend from an opening in the foot through the flange and the base to the equipment enclosure defining an enclosed wiring path for wiring utilities accessed through the floor. The wall mount adapter may include a wiring access through the back panel of the visitation station which may be joined to conduit in the wall providing utility wiring such as power, communication and sensors. The wiring access extends into the equipment enclosure.

The invention may provide interconnection between adjacent modules to allow indefinite number of side-by-side visitation modules ganged together. The module interconnection provides secure attachment between adjacent modules using divider panels. Wiring may be connected to adjoining visitation stations from the equipment enclosure through the top panel conduit opening, the wire raceway in the base, the wire channel in the divider panel or the wire access in the back panel. Back-to-back visitation station may be interwired through the equipment enclosure. Side-by-side visitation stations may be interwired through the wire channel in the divider panels.

A top panel may be used on top of each visitation station to secure equipment and connections behind the faceplate. The top panel may enclose the equipment enclosure defined behind the faceplate for mounting communication or video equipment. The faceplate may further comprise a solid mounting surface for externally mounted devices such as telephone equipment or microphones and cameras. A transparent window may be used to isolate the visitor from video equipment such as a video monitor for a visual interface between visitors. Each visitation module is thereby defined by the faceplate, writing surface on the base and end or divider panels. The top panel and the end panels having an anti-ligature configuration.

The above description sets forth, rather broadly, the more important features of the present invention so that the detailed description of the preferred embodiment that follows may be better understood and contributions of the present invention to the art may be better appreciated. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE SEVERAL VIEWS OF THE DRAWING

FIG. 1 is substantially a perspective view of a first embodiment of the invention.

FIG. 2 is substantially a perspective exploded view of the base of the first embodiment of the invention.

FIG. 3 is substantially a perspective exploded view of the top of the first embodiment.

FIG. 4 is substantially an exploded view of the front panel assembly of the first embodiment.

FIG. 5 is substantially an exploded perspective view of the final assembly of the first embodiment.

FIG. 6 is substantially a perspective view of a second embodiment.

FIG. 7 is substantially a perspective view of a third embodiment.

FIG. 8 is substantially a side elevation of the third embodiment.

FIG. 9 is substantially a top plan view of the third embodiment

### DETAILED DESCRIPTION OF THE INVENTION

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

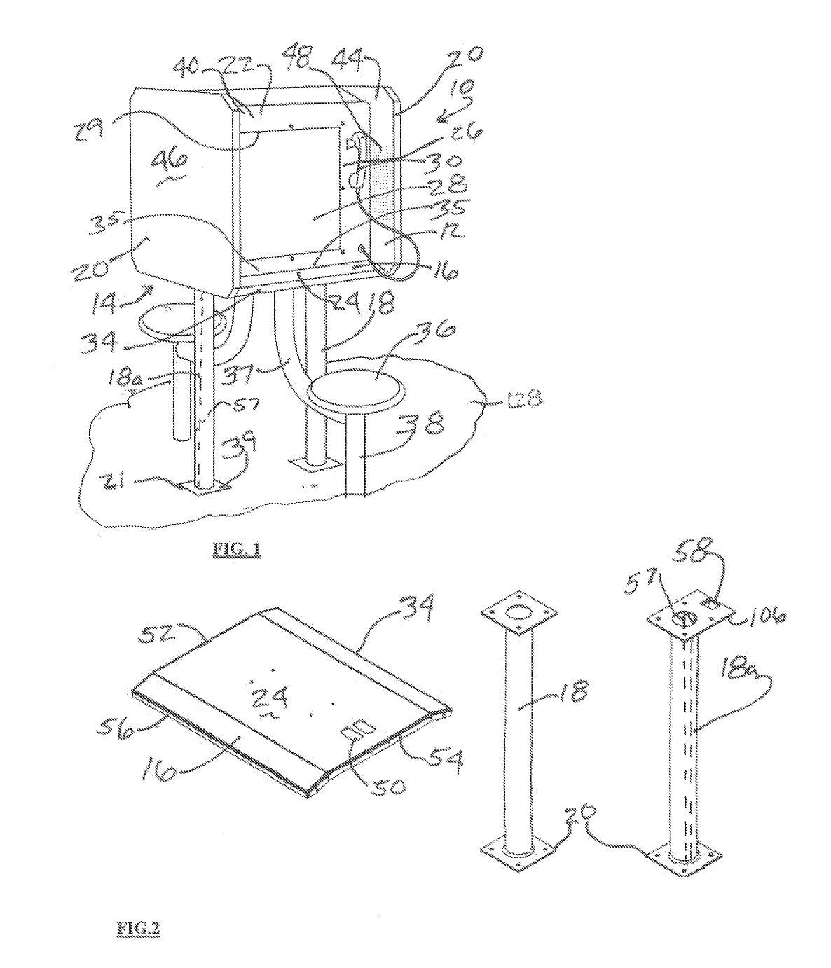

Referring to FIG. 1, the modular visitation station is generally referred to by the number 10 shown in a back-to-back or double sided configuration having a first visitation module 12 in the front and a second visitation module 14 attached in a back-to-back configuration. Each visitation module 12, 14 may further comprise a base 16, legs 18, end panels 20 and a first faceplate 22. Visitation station 10 components may be formed from steel, stainless steel, aluminum, engineered plastic such as Lexan® by GE, or other durable materials suitable for intensive use applications.

Continuing to refer to FIG. 1, the base 16 may further comprise a top 24 and a front edge 34. The top 24 may be adapted as a writing surface. The first faceplate 22 may further comprise, a right side 26, a top panel 40, a first bottom 35 and a transparent window 28 having an outside frame 29 mounted thereon and may be further adapted for mounting communication equipment such as hand set 30. A first seat 36 may be adapted to hold a visitor (not shown) seated in front of first visitation module 12 defined by base 16, front edge 34, first and second end panels 20 and faceplate 22. The first seat 36 is connected to the station 10 by first station link 37 and supported by first seat leg 38. Legs 18 may have feet 21 for securing to floor 128 with fasteners 39. Each end panel 20 may have an inside 44 and an outside 46. A sound absorber portion 48 may be formed on inside surface 44 of end panel 20.

Referring to FIG. 2, visitation station 10 may comprise base 16 having a front edge 34, first left end 52, first right end 54, back edge 56 and wire raceway 50 extending through base 16. Base 16 may further comprise an elongate configuration comprising a purality of side-by-side visitation modules between left end 52 and right end 54. Leg 18a may further comprise, a wire conduit 57 in the leg 18a, the wire conduit 57 having a bottom end opening to foot 21 and a top end in wiring communication with wire raceway 50 by wire opening 58 through the base flange 106, The wiring opening 58 adapted to align with wire raceway 50 when leg 18a is attached to base 16.

Referring to FIG. 3, the top portion of visitation station 10 may comprise a pair of faceplate frames 78, 78a mounted in spaced relation between end and divider panels 20, 60. Divider panel 60 may have sound absorber portion 48 on both sides 65 to isolate visitor noise from adjacent visitors and surrounding people. In this back-to-back configuration, first faceplate frame 78 and second faceplate frame 78a may be mounted in spaced relation between first end panel 20 and first divider panel 60. End panels 20 and divider panels 60 may have a similar rectangular form with each having a top edge 68, a bottom edge 72 and opposing outside edges 74. Top edge 68 may have an anti-ligature configuration having rounded or sloped corners 69. Mounting plate 70 may comprise spacer bar 61, first panel flange 62 and second panel flange 64. Mounting plate 70 may be attached to faceplate 22 at fasteners holes 59 on spacer bar 61 and further attached to end panels 20 by panel flange 62, 64 on panel inside 44 and divider panels 60 at either first side 65 or second side 66.

Continuing to refer to FIG. 3, First faceplate frame 78 and mounting plate 70 may be attached between panels 20, 60 by first panel flange 62 attaching to inside 44 with threaded fasteners 85 or the like in fastener holes 59 and second panel flange 64 likewise attaching to divider panel 60. First faceplate frame 78 may be attached to end panel 20 at first left member 80 and to divider panel 60 at first right member 82 by threaded fasteners 85 extending through members 80, 82. Second faceplate frame 78a may likewise be attached to divider panel 60 at second right member 82 and to end panel 16 at second left member 80. An equipment space configured as an equipment enclosure 92 may be defined between frames 78, 78a, end panel 20, divider panel 60 and base 16 with wiring raceway 50 formed in base 16 between first frame 78 and second frame 78a and wire channel 150 in divider panel 60. Equipment enclosure 92 provides space for mounting and power and communication connections for faceplate 22 and attached equipment (not shown). Both wiring raceway 50 and wire channel 150 open to enclosure space 92 to provide wiring between adjacent visitation stations and wiring to utility sources outside the visitation station 10.

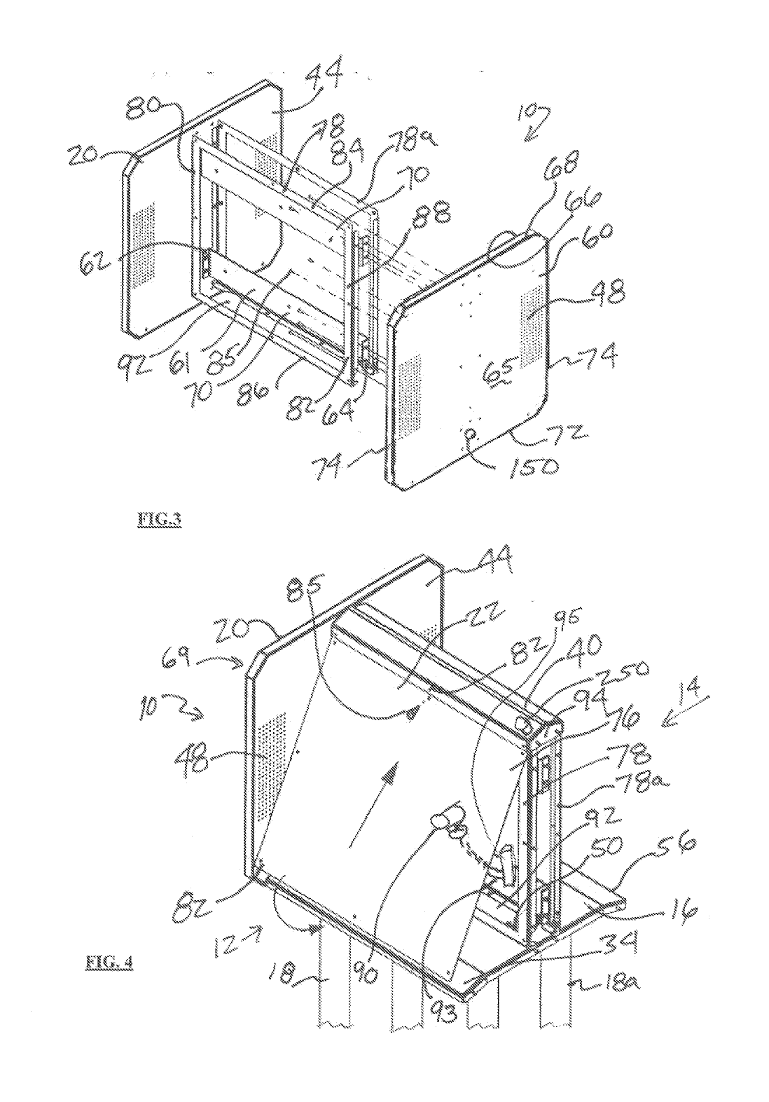

Referring to FIG. 4, the back-to-back visitation station 10 may define first visitation module 12 and second visitation module 14. Faceplate 22 may attach to a top plate 40 adapted to close the top of the equipment enclosure 92. Equipment such as camera 90 on faceplate 22 has wires 93 extending into equipment space 92 for connection to transmitter 95. Top plate 40 may be attached to top 84 of faceplate frame 78 and between end panels 20 and divider panel 60 above faceplate 22. Top plate 40 may further attach to both faceplate frames 78, 78a. Front panel 76 may be attached to frame 78 to close the equipment enclosure 92 between panels 20, 60. Top panel 40 may be attached to frame top 84 and to end or divider panels 20, 60. Top plate 40 may have panel flanges 94 for attaching to end and divider panels 20, 60. Conduit opening 250 may be formed in top plate 40 to provide wire access to equipment enclosure 92 from above visitation station 10. Faceplate 22 may further be disposed between top plate 40 and frame 78 to provide tamper resistant mounting and prevent removal without tools. Fasteners 85 may be used on faceplate 22 adjacent base 16 to hold faceplate 22 on equipment enclosure 92.

Referring to FIG. 5, visitation station 10 upper assembly 96 and lower assembly 98 may be separately assembled and attached to each other at the mounting site. Upper assembly 96 may comprise end panels 20 joined in spaced relation by mounting plate 70 and faceplate frame 78 attached to the inside surface 44 of each end panel 20 or divider panel 60. Lower assembly 98 may comprise base 16 having bottom surface 102. Legs 18 are attached to bottom surface 102 at flange 104. Faceplate frame screws 85 extend through base 16 to engage faceplate frame 78. Base ends 52, 54 are generally similar having a base flange 106 extending from base bottom surface 102 with panel fastener holes formed through base flange 106. Panel fastener holes in base flange 106 on first end 52 may be used to interconnect base 16 to end panels 20 or divider panels 60.

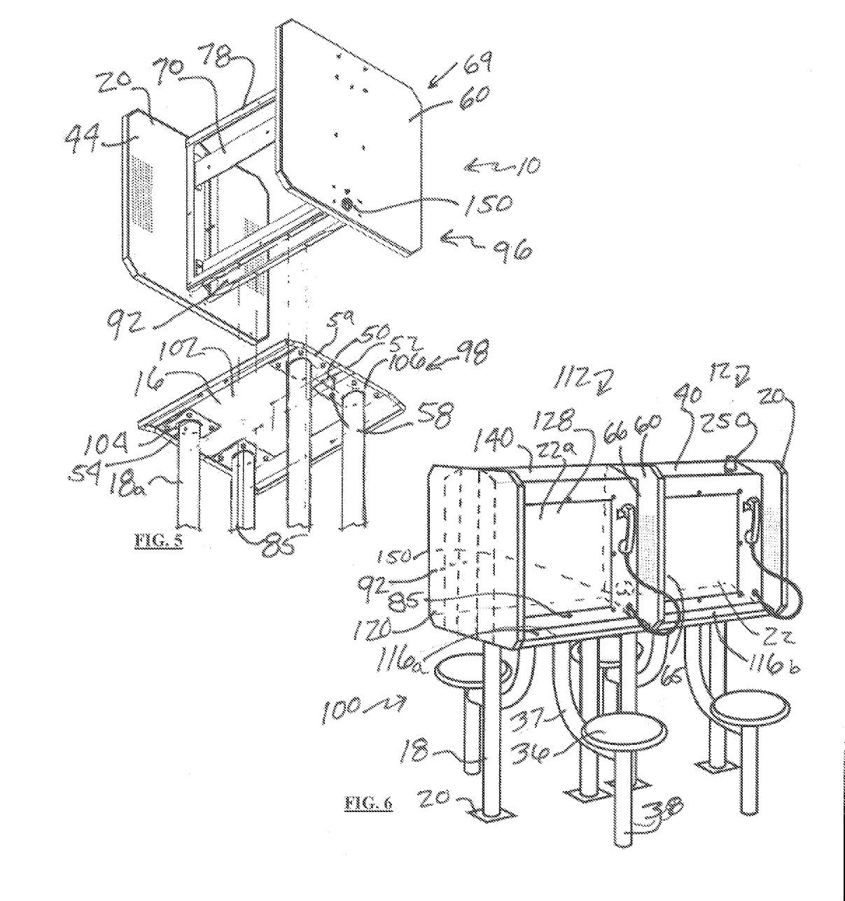

Referring to FIG. 6, modular visitation station 100 may comprise an additional visitation module 112 mounted side-by-side with first visitation module 12. Modular visitation station 100 may have a respective first and second end panel 20. Base 16 may extend between first end panel 20 and second end panel 120 or may be formed by assembling first base portion 116a with second base portion 116b. Divider panel 60 may be disposed between respective base portions 116a, 116b, faceplates 22, 22a and top panels 40, 140. The first base portion 116a is connected to the second base portion 116b by connecting both base portions 116a, 116b to divider panel 60.

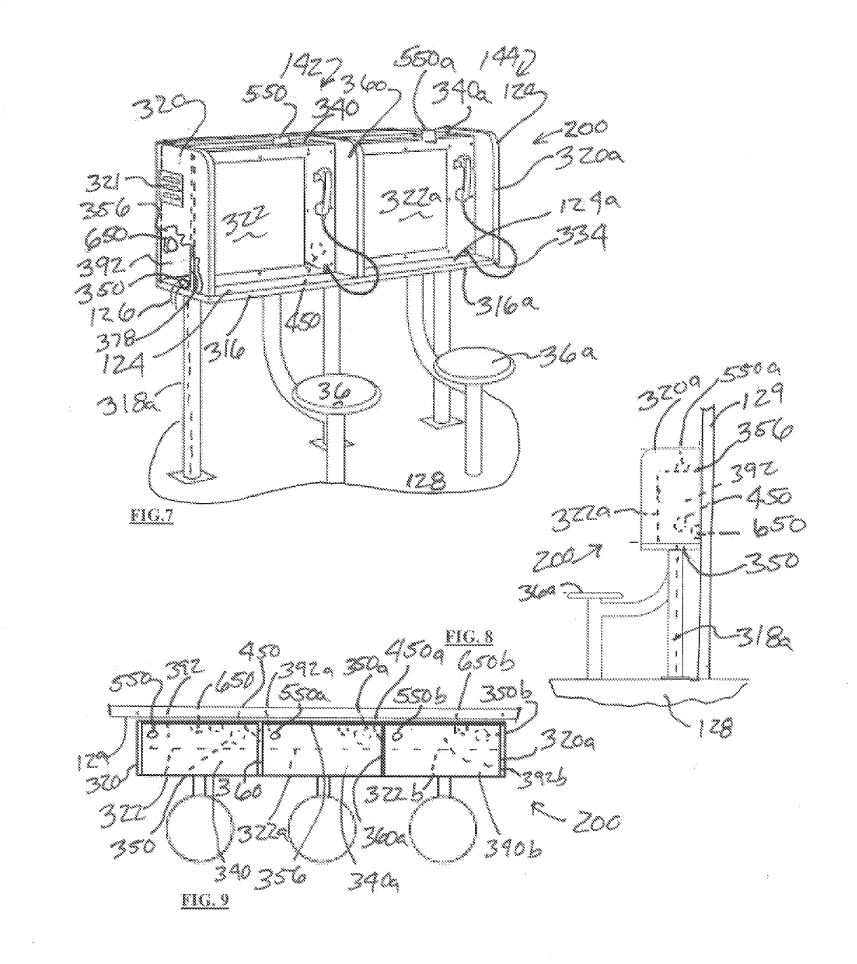

Referring to FIG. 7, modular visitation station 200 may have a plurality of single sided visitation modules 142, 144 adapted in a side-by-side configuration. First visitation module 142 and generally similar second visitation module 144 may be divided by divider panel 360. First visitation module 142 may have a base top 124 surrounded on three sides by first end panel 320, first faceplate 322 and divider panel 360. First end panel 320 may be connected to first faceplate 322 and first base 316. First visitation module 142 may further comprise back panel 356 on first base 316 to enclose and define equipment enclosure 392. The first visitation module 142 may be attached side-by-side to similarly configured second visitation module 144. Base 316 on first visitation module 142 may be connected between end panel 320 and divider panel 360 or configured as part of an elongate base 316 extending between the respective end panels 320, 320a. Base 316 may extend between end panels 320, 320a thereby supporting a plurality of visitation modules 142, 144. Additional visitation modules 144 may be added by replacing one end panel 320 with a new divider panel 360 and connecting faceplate 322, top 340 and base 316 to new divider panel and likewise reconnecting end panel 320 to close the new configuration. Equipment enclosure 392 is between base 316, top 340 end panel 320, divider panel 360, faceplate 322 and back panel 356. Conduit opening 550 may be formed in top 340, wire raceway 350 in leg 318a extending through base 360 and wire channel 450 in divider panel 360 each provide access to wiring 126 to enter equipment enclosure 392. Divider panel 260 may be connected between visitation modules 142, 144 and back panel 356.

Continuing to refer to FIG. 7, side-by-side second base 316a may be generally similar to first base 316 both of which may be attached to divider panel 360. Second faceplate 322a and second end panel 220a may be attached to second base 316a to form second visitation module 144. First seat 36 is fixed to first visitation module 142 and second seat 36a is fixed to second visitation module 144. Back panel 356 may extend between end panels 320 or be individually configured for each visitation module 142, 144 to be sized and connected similar to the respective faceplate 322. End panel may have vent 321 opening to equipment enclosure 392.

Referring to FIG. 8, modular visitation station 200 wire raceway 350 may open into equipment enclosure 392 from floor through leg 318a at wire track 350 extending through base 316. First visitation module 142 and second visitation module 144 may be attached and interwired to each other by wire channel 450. Modular visitation station 200 may have faceplate 322, 322a spaced from back panel 356 having equipment enclosure 392 between faceplate 322 and back panel 356. Rear wire access 650 on back panel 356 may extend through back panel 356 to open into equipment enclosure 392. Wall mounted modular visitation stations 200 may not require legs 318.

Referring to FIG. 9, visitation station 200 may comprise several visitation modules 142, 144 each having equipment enclosures 392, 392a, 392b, faceplates 322, 322a, 322b and separated by divider panels 360, 360a. Equipment enclosures 392, 392a, 392b may be interwired by wire channel 450 in each divider panel 360, 360a to allow a single utility connection to service all attached equipment enclosures 392, 392a, 392b. Conduit access 550, 550a, 550b in top panel 340, 340a, 340b provides wiring access from above modular visitation station 200. Wire raceway 350 in base 316 provides wire access from below visitation station 200 and may provide interwiring access between equipment enclosures 392, 392a, 392b. Rear wire access 650 may provide wiring access through the back panel 356.

Although the description above contains many specifications, these should not be construed as limiting the scope of the invention but as merely providing illustrations of some of the embodiments of this invention. Thus, the scope of the invention should be determined by the appended claims and their legal equivalents rather than by the examples given. Further, the present invention has been shown and described with reference to the foregoing exemplary embodiments. It is to be understood, however, that other forms, details, and embodiments may be made with out departing from the spirit and scope of the invention which is defined in the following claims.

We claim:

1. A modular visitation station comprising:
a first visitation module having a base, a first top panel, a first faceplate and a first end panel, the first base having a top side, a bottom side, a first and second opposing sides, a front edge, the first faceplate, the first end panel having an inside, the first end panel attached to the base, the faceplate attached to the top of the base and the first end panel, the top panel attached to the first end panel and the first faceplate, a conduit access in the top panel, a wiring raceway in the base opening from the bottom side to the top side of the base, first faceplate on the top side of the first base;
a second visitation module having a second faceplate and a second end panel, the second faceplate on the base, the second faceplate attached to the second end panel, the second faceplate spaced from the first faceplate, the second end panel connected to the base; and
an equipment enclosure on the base, the wiring raceway in the equipment enclosure, the first top panel on the equipment enclosure, the first faceplate on the equipment enclosure, the equipment enclosure in wiring communication with the first faceplate and the second faceplate.

2. The invention of claim 1, further comprising a divider panel and a second top panel, the divider panel between the first visitation module and the second visitation module having a first side attached to the first faceplate and a second side attached to the second faceplate, the divider panel on the base, a wiring channel in the divider panel, the second top panel on the second end panel.

3. The invention of claim 2, further comprising a second equipment enclosure adjacent to the second faceplate, the second top panel on the second equipment enclosure.

4. The invention of claim 1, wherein the first faceplate is attached to the second end panel, the second faceplate attached to the first end panel, the equipment enclosure disposed between the first faceplate and the second faceplate.

5. The invention of claim 1, further comprising a leg, the leg having a base flange a foot and a wire conduit, the base flange attached to the bottom side of the first base, the base flange having a wire opening through the base flange, the wire conduit having a top end in the wire opening, the wire conduit having a bottom end on the foot.

6. The invention of claim 3, further comprising a back panel, the back panel attached to the first end panel, the back panel attached to the second end panel, the first equipment enclosure on the back panel, the second equipment enclosure on the back panel, material removed from the back panel to form a rear wire access extending through the back panel into the equipment enclosure.

7. The invention of claim 3, wherein the base further comprises a first base portion and a second base portion, the first base portion on the first frame, the first base portion attached between the first end panel and the divider panel, the second base portion on the second frame, the second base portion attached between the divider panel and the second end panel, the first equipment enclosure on the first base portion, the second equipment enclosure on the second base portion.

8. The invention of claim 1 wherein the first end panel is connected to the second faceplate, the second end panel is connected to the first faceplate, the first equipment enclosure between the first faceplate and the second faceplate, the first equipment enclosure between the first end panel and the second end panel, the first equipment enclosure between the base and the first top panel whereby first end panel is in spaced relation to the second end panel having the first and second faceplates there between, the first visitation module and the second visitation module in a back-to-back configuration.

9. A modular visitation station comprising:
a first visitation module having a first base, an equipment enclosure, a first end panel, a first top panel and a first and second faceplate, the first base having a left side, a right side, a front, a back, a bottom side and a top side, the leg on the bottom side, the first end panel on the left side of first base, a wire raceway extending through the first base from the bottom side to the top side, the first faceplate on the top side of the first base between the wire raceway and the front, the second faceplate on the top side of the first base between the wire raceway and the back of the first base, the first and second faceplates attached to the first end panel in spaced relation, the top panel attached to the first end panel, the top panel on the first and second faceplates, a conduit access in top panel in wiring communication with wire raceway, the equipment enclosure between the first and second faceplates, the wire raceway opening into the equipment enclosure.

10. The invention of claim 9, further comprising a second end panel, the second end panel attached to right side of the first base, the second end panel attached to the first and second faceplates, the second end panel attached to the top panel.

11. The invention of claim 9, further comprising a divider panel, a second base, a second top panel, a third faceplate and a second end panel, the divider panel having a first side, a second side and a wire channel extending from the first side to the second side, the second base having a left side, a right side, a front, a back, a bottom side and a top side, the first side of the divider panel attached to the right side of the first base, the first side of the divider panel attached to the first and second faceplates and the first top panel, the first and second faceplates between the first end panel and the divider panel, the second side of the divider panel on the left side of the second base, the third faceplate on the second side of the divider panel, the second top panel on the second side of the divider panel, the second end panel attached to the second base, the second end panel attached to the third faceplate, the second end panel on the second top panel whereby the second end panel is spaced from the divider panel.

12. The invention of claim 11, further comprising a second equipment enclosure on the second base adjacent the third faceplate, a second wire raceway in second base, the second wire raceway extending from the bottom side of second base to top side of the second base opening into second equipment enclosure.

13. The invention of claim 10 further comprising a leg, the leg comprising a foot, a base flange and a wire conduit, the base flange attached to the bottom side of first base, the wire conduit in the leg having a top end, and a bottom end on the foot, a wire opening in the base flange, having a wire opening through the base flange, the top end in the wire opening, the wiring opening disposed on the wire raceway.

14. The invention of claim 11, further comprising a second conduit access on the second top plate.

15. A modular visitation station comprising:
a first visitation module having a base, a back panel, a first end panel, a first top panel and a first faceplate, the base having a left side, a right side, a front, a back, a bottom side and a top side, the back panel on the back of the base, the first end panel on the left side of the base, the first faceplate on the first end panel, the first faceplate on the top of the base between the back panel and the front of the base, a first equipment space between the first faceplate and the back panel, the first top panel on the back panel and the first faceplate, a wire raceway extending through the base from the bottom side to the top side in the first equipment space;
a second visitation module on the base, the second visitation module having a first divider panel, a second end panel, a second top panel and a second faceplate, the first divider panel having a wire channel, an anti-ligature top, a bottom, a first side and a second side, the bottom of the divider panel on the base in spaced relation to the first end panel, the first side of the divider panel attached to the first faceplate and the first top panel, the second side of the divider panel attached to the second faceplate and the second top panel, the second faceplate on the second top panel and the second end panel, the second end panel on the back panel and base in spaced relation to and generally parallel to the first end panel and the first divider panel, a second equipment space between the second faceplate and the back panel, a second wire raceway extending through the base from the bottom side to the top side in the second equipment space, material removed from the first divider panel to form the wire channel from the first equipment space to the second equipment space.
